(19) United States
(12) Patent Application Publication
(10) Pub. No.: US 2012/0003989 A1
(43) Pub. Date: Jan. 5, 2012

(54) Location Status Update Messaging

(75) Inventor: Douglas David Gravino, Roswell, GA (US)

(73) Assignee: Cox Communications, Inc., Atlanta, GA (US)

(21) Appl. No.: 12/828,768

(22) Filed: Jul. 1, 2010

(51) Int. Cl. H04W 64/00

(52) U.S. Cl. 455/456.1

(57) ABSTRACT

Provision of a location status update for a mobile computing device to a recipient based on navigation information is disclosed. The location status update may be sent to one or more recipients based on a predetermined criterion or upon user command. According to embodiments, a mobile device's GPS and/or network-based location technologies may be utilized to provide information as to whether a predetermined criterion is met. The location status update may be an SMS or MMS message, an e-mail, a text message, a voice call, a voice message, or a posting to a social networking site.

### BACKGROUND

When traveling to a particular destination, it is common to call or text a person at the destination when one is getting close to the destination. For example, when a person is driving to visit family out of state, the person traveling may make a call to his/her family when he/she is approximately halfway there, or thirty minutes away, or when crossing a final state boundary. For local trips when meeting friends, a person may call his/her friends to say, “I'm five minutes away.” Unfortunately, due to dangers of dialing or texting while driving, these habits are considered to be unsafe, and in some states, illegal.

It is with respect to these and other considerations that the present invention has been made.

### SUMMARY

Consistent with embodiments of the present invention, systems and methods are disclosed for providing a location status update to one or more recipients based on navigation information.

Many new mobile phones have a location determining system, such as a global positioning system (GPS). Those that don't may be able to connect to a server to analyze their signals and determine their location or may determine location via an accelerometer mechanism or wireless-based (e.g., WIFI) location determining system. According to embodiments of the present invention, based on location data obtained by a mobile device's location determining system (e.g., GPS, network-based location technology, etc.), a location status update may be sent to a recipient based on a predetermined location status update criterion or upon user command. A recipient may be a person or persons associated with a particular destination address or a person whom a user specifies. Criteria that may trigger a location status update may include, but are not limited to, a particular distance traveled or remaining; being within proximity of a national, state, local, or other geographic boundary, landmark, or feature; being within proximity of a landmark; being within proximity of a specified location; a specified time since departure, a specified period of estimated time remaining until arrival, or a predetermined time interval. The location status update may be an email, an SMS or MMS message, a social network posting, a phone call, a text message, a voice message, a message displayed on a television via a set-top box or other network-connected device, such as an Internet-connected video appliance or device, or other notification method as is known in the art.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

FIG. 1 is a simplified block diagram of an architecture that serves as an exemplary operating environment for the present invention.

FIG. 2 is an illustration of an example scenario for providing a location status update.

FIG. 3 is an illustration of an example location status update displayed on a television according to an embodiment;

FIG. 4 is a flow diagram of a method for providing a location status update;

FIG. 5 is a block diagram of a mobile computing device 100 with which embodiments of the present invention may be practiced;

FIG. 6 is a block diagram of a cable television/services (CATV) system 108 with which embodiments of the present invention may be practiced.

### DETAILED DESCRIPTION

As briefly described above, embodiments of the present invention are directed to providing a location status update to one or more recipients based on navigation information. Generally described, according to embodiments, methods, systems and computer readable media provide for a location status update associated with a mobile computing device to be sent to one or more recipients based on receiving a request to send a location status update and upon a predetermined location status update criterion for sending the location status update being met.

According to embodiments, a mobile device's location determining technologies may be utilized to provide information as to whether a predetermined criterion is met. A receiving station of a wireless provider may receive and compare location status information with predetermined criteria. If a criterion is met, or upon user command, a location status update may be sent to a recipient. Criteria that may trigger a location status update may include, but are not limited to, a particular distance traveled or remaining; being within proximity of a national, state, local, or other geographic boundary, landmark, or feature; being within proximity of a landmark; being within proximity of a specified location; a specified time since departure, a specified period of estimated time remaining until arrival, or a predetermined time interval. The location status update may be an email, an SMS or MMS message, a social network posting, a phone call, a text message, a voice message, a message displayed on a television via a set-top box or other network-connected device, or other notification method as is known in the art.

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

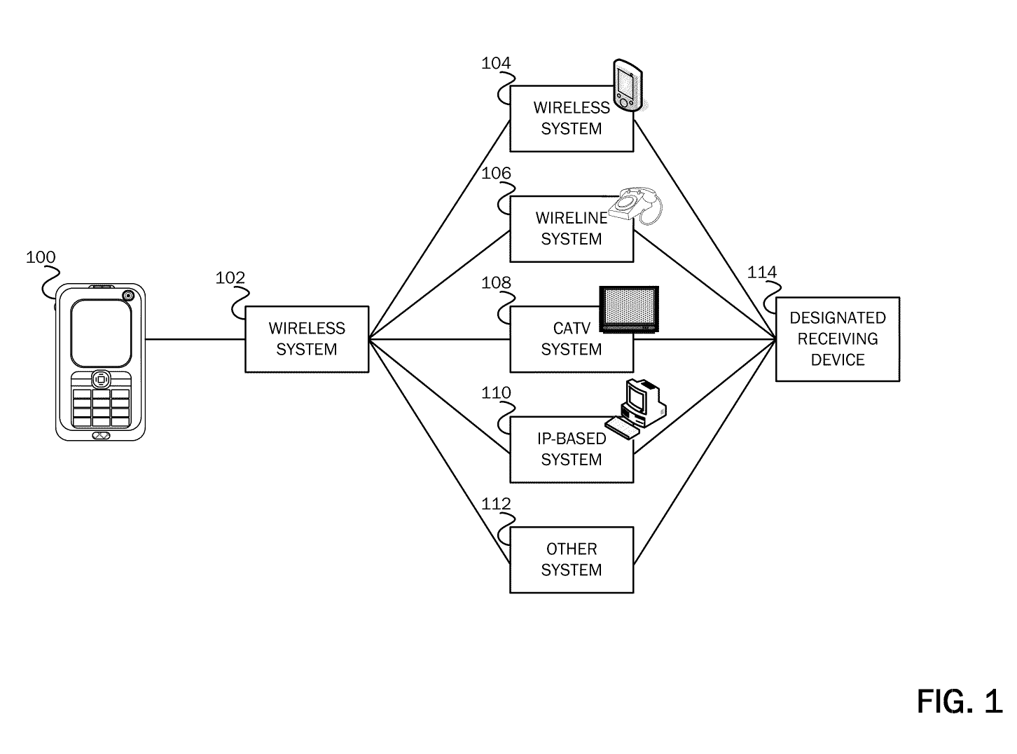

FIG. 1 is a simplified block diagram illustrating a wireless and wire line telecommunications, CATV, and IP-based architecture that serves as an exemplary operating environment for the present invention. The architecture illustrated in FIG. 1 shows a wireless system 102 in which wireless communication services may be provided to and from a wireless communications device 100, such as a mobile phone. A wireless device may communicate a location status update with other communications devices 114 through various communications systems, including wireless networks 104, wire line or public switched telephone networks (PSTN) 106, cable television services system (CATV) networks 108, and IP-based networks 110. As should be understood, the example communications/services network architecture illustrated in FIG. 1 is for purposes of illustration only and is not limiting of a variety of communications configurations that may be utilized as described herein.

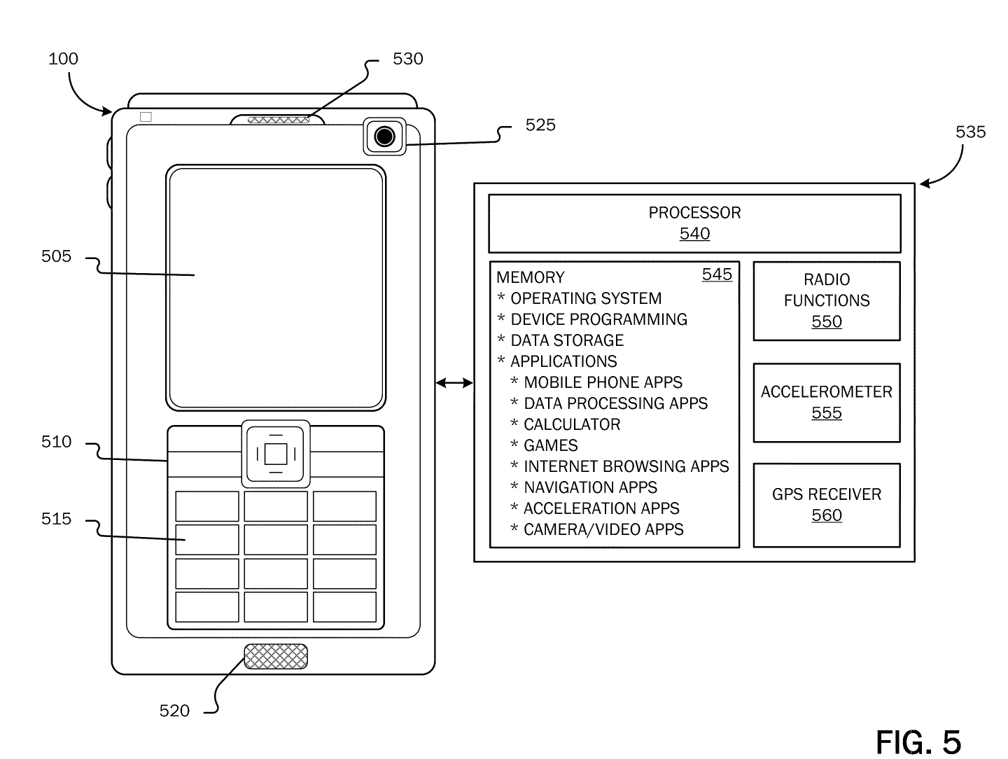

As should be appreciated, wireless communication services provided by service provider companies through a wireless network 102 is well known to those skilled in the art, and will not be discussed in detail herein. Referring still to FIG. 1, a wireless network 102 may employ the use of a wireless electronic communication device 100 (e.g., wireless phone, personal digital assistant (PDA), smart phone, etc.) capable of sending and receiving communications in the same frequency range as the wireless communications system. The term “mobile or wireless device” will be used herein to describe a wireless electronic communication device capable of sending and receiving wireless communications. As is understood by those skilled in the art, wireless devices 100 may comprise, but are not limited to, internal circuit boards, antennae, liquid crystal displays (LCD), keyboards, microphones, speakers, and batteries. All of these components and systems making up wireless devices 100 work together to send, receive, and manage communications within and beyond the cellular network 102. A wireless device 100 will be described in further detail herein with reference to FIG. 5.

A wireless system 102 may serve as control point for determining, providing and controlling subscriber features (e.g., location status update services), as well as for receiving and comparing a location status with predetermined criteria data (e.g., a particular distance traveled or remaining; being within proximity of a national, state, local, or other geographic boundary, landmark, or feature; being within proximity of a specified location; a specified time since departure, a specified period of estimated time remaining until arrival, etc.). If it is determined that a predetermined criterion has been met, a location status update may be sent through a communications network (104, 106, 108, 110, 112) to a designated receiving device 114.

According to another embodiment, a location status may be determined and compared with predetermined criteria data locally on a wireless device 100. An application on a wireless device 100 may be utilized to determine a location and compare the location with predetermined criteria, as well as to send a location status message.

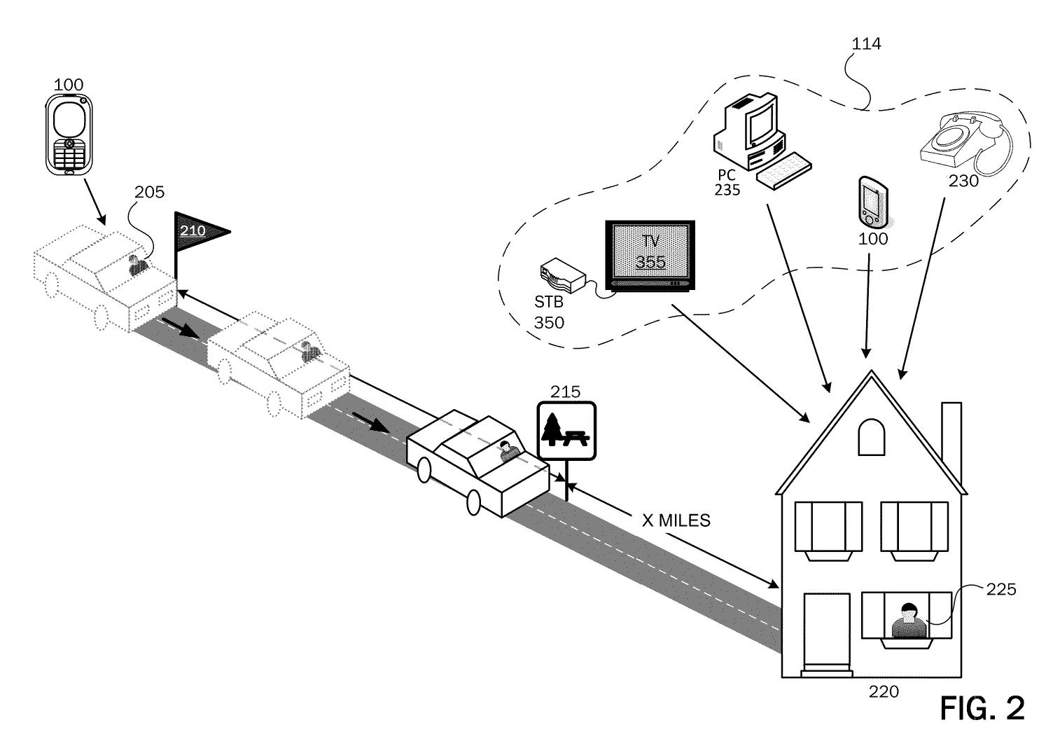

FIG. 2 is an illustration of how embodiments of the present invention may be used to communicate a location status of a user of a mobile computing device 100 to a recipient. Referring now to FIG. 2, a user 205 of a mobile computing device 100 is illustrated traveling in a vehicle starting at a starting point 210 and traveling toward a destination 220. Although the user 205 is illustrated as traveling in a vehicle, and the vehicle is shown as an automobile, it is not required that the user be in a vehicle. Accordingly, the user 205 may be walking, running, biking, etc. If the user 205 is traveling in a vehicle, the vehicle may be one a various types of vehicles, including but not limited to, an automobile, a train, a bus, a motorcycle, an airplane, etc. According to embodiments, the mobile computing device 100 may be equipped with a GPS system 560 (described below with reference to FIG. 5), wherein the GPS system 560 is operative to determine the user's 205. Once the user's location has been determined, the GPS system 560 may calculate other information, such as speed, bearing, track, trip distance, distance to destination 220, sunrise and sunset time and more.

According to embodiments, if a mobile computing device 100 does not comprise a GPS system 560, network-based location technologies, accelerometer mechanisms, or wireless positioning systems, for example, WIFI-based systems, may be utilized to provide location information. According to one embodiment, a location of a mobile computing device may be determined via a reference network comprised of known location of wireless access points (i.e., wireless positioning system or WPS). Wireless access points and their locations may be used by a mobile computing device to triangulate a user's position. WPS may be combined with cellular tower triangulation and GPS to provide location data. Mobile computing device 100 may utilize other location determining means, such as client software that may compute the device's location by cell identification and signal strengths of home and neighboring cells. Mobile computing device 100 may utilize a service provider's network infrastructure to identify a location of the device. A hybrid positioning system may also be utilized for location determination, wherein the hybrid system may use a combination of network-based and device-based technologies to compute a location.

According to embodiments, a predetermined criterion 215 may be entered into the mobile computing device 100, wherein when the criterion 215 is met, a location status update may be communicated to a recipient 225. Alternatively, a status update may be manually entered or selected by a user 205 to send to a recipient 225. The recipient 225 may be any person whom has been specified to receive a location status update. The recipient 225 may be a person associated with the user's destination 220 as illustrated in FIG. 2. Alternatively, the recipient 225 may be a parent, spouse, child, friend, or social contact of the user 205, or may be any other person who has been specified to receive a location status update.

According to embodiments, the predetermined criterion 215 that may trigger a location status update may include, but is not limited to, a particular distance traveled or remaining; being within proximity of a national, state, local, or other geographic boundary, landmark, or feature; being within proximity of a specified location; a specified time since departure, a specified period of estimated time remaining until arrival, or a predetermined time interval (e.g., every thirty minutes, every hour, etc,). As is illustrated in FIG. 2, the predetermined criterion 215 is being within proximity of a specified geographic landmark. In this example, the specified geographic landmark is a picnic area. Upon meeting the predetermined criterion 215, in this example, being within proximity of the specified geographic landmark, a location status update may be sent to one or more specified recipients 225.

According to embodiments, the location status update may be in the form of an e-mail, an SMS or MMS message, a text message, a voice message, a social network posting, a phone call, a message to a set-top box 350 to be displayed on a television 355, or other notification method as is known in the art. The location status update may be sent to one or more of a variety of communication and/or computing devices, including but not limited to, a STB 350, a mobile computing device 100, a computer 235, a wire line phone 230, a network-connected video device, for example, an Internet-connected video appliance, or software-based widgets that run on a variety of network-capable television sets, or any other device capable of receiving an electronic message or call. The location status update may include information such as, but not limited to, a departing time and/or location, an estimated time remaining until arrival, travel conditions including weather and/or traffic, location information, a distance traveled and/or remaining, a predetermined message from the user 205, a selected message from the user, an entered message from the user, or a phone call to a recipient 225.

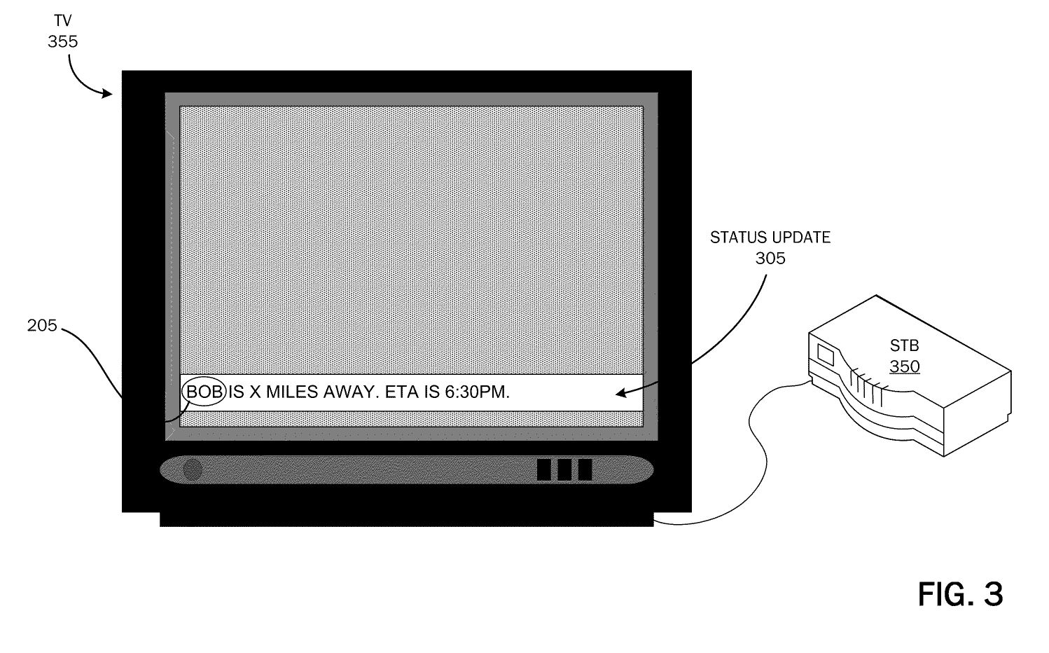

Referring now to FIG. 3, an example of a location status update 305 is illustrated according to an embodiment of the present invention. In this example, the location status update 305 has been sent to a STB 350 to be displayed on a TV 355 of a recipient 225. The location status update 305 includes information that the user 205 (in this example, Bob) is a certain distance away from his destination 220 (X miles away), along with an estimated time of arrival. As was described earlier, when a predetermined criterion 215 has been met or upon user 205 entry or selection, a location status update 305 may be sent to a recipient 225. In the example illustrated in FIG. 2, the predetermined criterion 215 is being within proximity of a specified geographic landmark. Upon this criterion 215 being met, as determined via a GPS system 560 or via network-based location technologies, the location status update 305 is transmitted. It should be appreciated that the illustrations of FIGS. 2 and 3 are for example only, and not meant to limit the scope of the present invention. The predetermined criterion 215 may be one or more of a variety of criteria, the location status update 305 may be sent to one ore more of a variety of receiving devices, and the information contained in the location status update 305 may contain a variety of information. That is, the location status update may be sent to a variety of receiving devices (e.g., wireless phones, personal digital assistants (PDA), smart phones, computers, set-top box/television combinations, etc.) in a manner described above with reference to FIG. 1.

### Example Location Status Update Messaging

Routine trip: According to one example use case, a routine trip may be a common recurring usage, such as a drive home from work. For example, a user 205 may leave his/her place of business 210, and may be traveling home 220. The user 205 may wish for a location status update 305 to be sent to his/her spouse, child, parent, friend, and/or other recipient 225 to alert the recipient of one or more of a variety of status information such as, but not limited to when he/she 205 left his/her place of business 210 or when he/she is a certain distance away from or an estimated time of arriving home 220. The location status update 305 may be a phone call, a text message, an e-mail, a message sent to a STB 350, via the CATV system 108 for display on the recipient's television 355.

Social engagement: According to another example, a social engagement may be a scenario in which a user 205 may be traveling to a social engagement, such as attending an event or a dinner with friends. The user 205 may wish for a location status update 305 to be sent to the friends or others whom he/she may be meeting 225. The location status update 305 may include information such as how far away the user 205 is from his/her destination 220 in distance or estimated time. According to one embodiment, the location status update 305 may be posted to a social networking site, wherein a notification may be sent to social networking “friends”. According to another embodiment, the location status update 305 may be a phone call, a text message, an e-mail, a message sent to a friend's receiving wireless phone 100 via the wireless system 104.

Long trip: According to another example use case, a long trip may be a scenario in which a user 205 may be traveling to a destination 220 that may not be a common everyday trip, for example, a trip to a relative's home for a holiday celebration. The user 205 may wish for a location status update 305 to be sent to a recipient 225 to inform the recipient of his/her location or progress. For example, the user 205 may wish to alert his/her relative 225 that he/she is a certain distance away. Or, as another example, the user 205 may be a college student traveling to school 220, and he/she may wish to notify his/her parents 225 that he/she is a certain distance away from arriving at his/her school or that he/she has passed a state line or other detectable geographic location 215. A long trip may be a scenario in which a user 205 may be traveling on an airplane, train, bus, or other type of transportation vehicle. A predetermined criterion 215 may be when the user 205 reaches a specified airport, train station, or bus station, or when he/she is a specified altitude or velocity. When the criterion is met, a location status update message may be sent to the desired recipient, for example, to the recipient's email address via an IP-based system 110, described above.

As should be appreciated, the above scenarios are not meant to limit the present invention, but are meant to illustrate various scenarios in which a location status update 305 may be sent to a recipient 225.

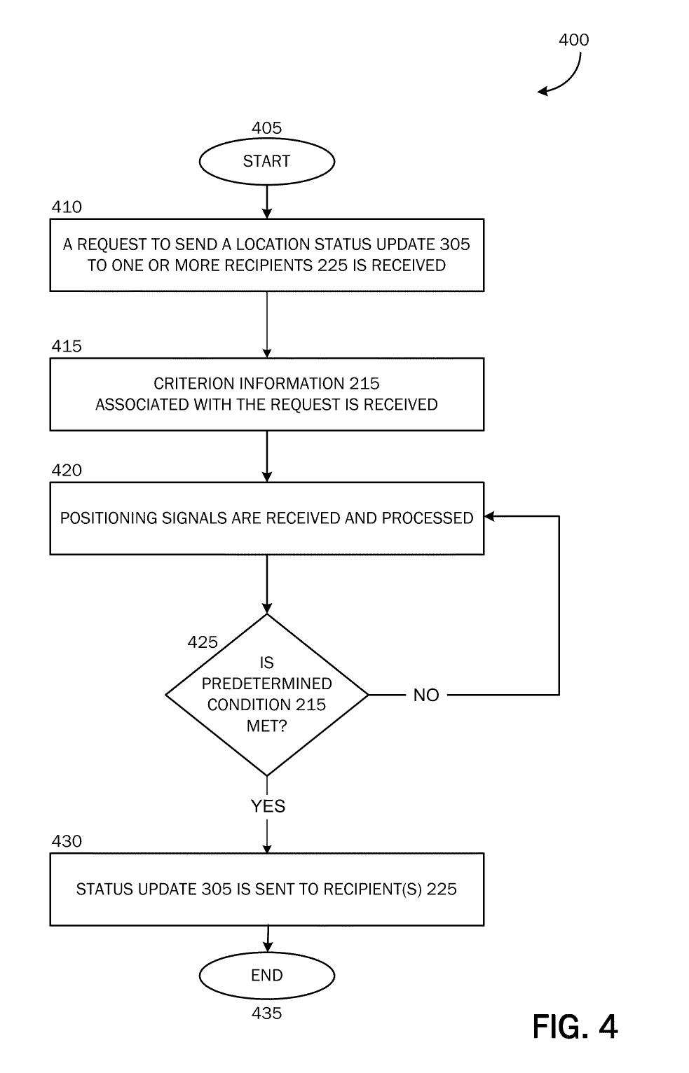

Having described example use cases of sending a location status update 305 according to embodiments of the present invention, FIG. 4 is a flow diagram of a method 400 for sending a location status update 305 to a recipient 225 based on navigation information.

The method 400 starts at OPERATION 405 and proceeds to OPERATION 410, where a request to send a location status update 305 to one or more recipients 225 is received. During OPERATION 410, a user 205 may enter navigation information into his/her device 100 for planning a route to a destination 220 or to obtain directions to a destination. The user 205 may enter or select a starting point 210 and a destination address 220. According to embodiments, information associated with a recipient 225 may be entered or selected by a user 205. Recipient information may include, but is not limited to, a recipient's name, a recipient's phone number, a recipient's e-mail address, information associated with a social networking contact, or a unique identification number associated with a device capable of receiving a location status update or call.

The method 400 proceeds to OPERATION 415, where information regarding one or more predetermined criteria 215 are entered into a mobile computing device 100 or selected from a list. As described above, a predetermined criterion 215 may include, but is not limited to, a particular distance traveled or remaining; being within proximity of a national, state, local, or other geographic boundary, landmark, or feature; being within proximity of a specified location; a specified time since departure, or a specified period of estimated time remaining until arrival.

The method 400 proceeds to OPERATION 420, where positioning signals are received and processed. If the mobile computing device 100 is equipped with a GPS system 560, the GPS system may receive positioning signals transmitted from satellites. The positioning signals may be processed, wherein mobile, navigation, as well as other travel information may be determined. Mobile information may contain coordinates of longitude and latitude, direction of travel, and speed. Navigation information may contain directions to a given destination 220. Other travel information may contain information related to traffic, weather, fuel prices, road conditions and construction, points of interests, etc. Mobile computing device 100 may utilize other location determining means, such as client software that may compute the device's location by cell identification and signal strengths of home and neighboring cells. Mobile computing device 100 may utilize a service provider's network infrastructure to identify a location of the device. A hybrid positioning system may also be utilized for location determination, wherein the hybrid system may use a combination of network-based and device-based technologies to compute a location. According to one embodiment, at a prescribed frequency (e.g., every 10 seconds or every 1 mile traveled), navigation information thus determined may be sent from the device 100 to the wireless system 102 for comparing with the predetermined criterion 215.

The method 400 proceeds to DECISION OPERATION 425, where a determination is made as to whether the predetermined criterion 215 entered or selected in OPERATION 415 is met. For example, referring back to the example illustration in FIG. 2, if the predetermined criterion 215 is being within proximity of a given geographic landmark, and if the device 100 is within proximity of the given geographic landmark as determined by received and processed positioning signals, then the predetermined criterion 215 has been met.

If it is determined that the predetermined criterion 215 has been met, the method 400 proceeds to OPERATION 430 where a location status update 305 is sent to one or more recipients 225. As mentioned earlier, the location status update 305 may include information such as, but not limited to, a departing time and/or location, an estimated time remaining until arrival, travel conditions including weather and/or traffic, location information, a distance traveled and/or remaining, a predetermined message from the user 205, a selected message from the user, an entered message from the user, or a phone call to a recipient 225. The method 400 ends at OPERATION 435.

FIG. 5 is a block diagram of a mobile computing device with which embodiments of the present invention may be practiced. The mobile computing device 100 is illustrative of any suitable device, such as a mobile telephone, personal digital assistant (PDA), or handheld computer, operative to send, receive and process wireless communications according to embodiments of the present invention. A display screen 505 is operative for displaying a variety of information such as information about incoming and outgoing communications, as well as, a variety of data and displayable objects, for example, text, alphanumeric data, photographs, and the like.

Data input to the device 100 may be performed via a variety of suitable means, such as, touch screen input via the display screen 505, keyboard or keypad input via a data entry area 510, key input via one or more selectable buttons or controls 115, voice input via a microphone 520 disposed on the device 100, photographic input via a camera 525 functionality associated with the mobile computing device, or any other suitable input means. Data may be output via the device 100 via any suitable output means, including but not limited to, display on the display screen 505, audible output via an associated speaker 530 or connected earphone system, vibration module for providing tactile output, and the like.

Operational unit 535 is illustrative of internal operating functionality of the mobile computing device 100. A processor 540 is illustrative of a general purpose computer processor for processing incoming and outgoing data and communications and controlling operation of the device and associated software applications via a mobile computing device operating system. Memory 545 may be utilized for storing a device operating system, device programming, one or more stored applications, for example, mobile telephone applications, data processing applications, calculators, games, Internet browsing applications, navigation applications, acceleration applications, camera and/or video applications, etc. Mobile computing device 100 may contain an accelerometer 555 for detecting acceleration, and can be used to sense orientation, vibration, and/or shock. Mobile computing device 100 may contain a global positioning system (GPS) system (e.g., GPS send/receive functionality) 560, which when coupled with a navigation application, can pinpoint the device's 100 location, give directions to a provided destination, and may provide information about nearby businesses. A GPS system 560 uses radio waves to communicate with satellites orbiting the Earth. Some GPS-enabled mobile computing devices use wireless-assisted GPS to determine a user's location, wherein the device uses orbiting GPS satellites in conjunction with information about the device's mobile phone signal. Radio functions 550 include all required functionality, including onboard antennae, for allowing the device 100 to communicate with other communication devices and systems via a wireless network 102. Radio functions 550 may be utilized to communicate with a wireless or WIFI-based positioning system to determine a device's 100 location.

Although described herein in combination with mobile computing device 100, in alternative embodiments the invention may be used in combination with any number of computer systems, such as in desktop environments, laptop or notebook computer systems, multiprocessor systems, micro-processor based or programmable consumer electronics, networked PCs, mini computers, main frame computers and the like. Embodiments of the present invention may be utilized in various distributed computing environments where tasks are performed by remote processing devices that are linked through a communications network in a distributed computing environment, and where programs may be located in both local and remote memory storage.

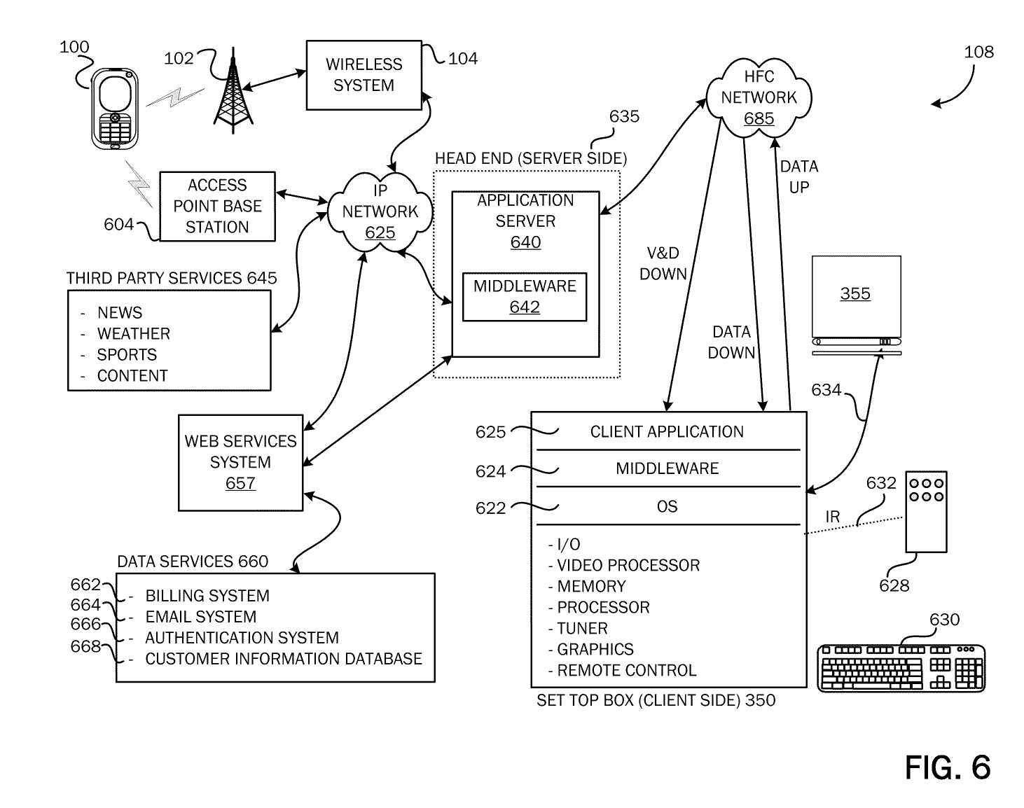

A user of a mobile computing device 100 operating in a converged services environment may utilize the mobile computing device to access one or more applications, features or services via one or more disparate and/or remote systems via a wireless network through which the device operates. As described above, according to one embodiment, the location status update alert/message may be sent to the desired recipient via a cable television services system for display on the recipient's television set via a set-top box. With reference to FIG. 6, a cable television/services system (hereafter referred to as “CATV”) architecture 108 that may serve as an exemplary operating environment for this embodiment of the invention is described.

Referring now to FIG. 6, digital and analog video programming, information content and interactive television services are provided via a hybrid fiber coax (HFC) network 685 to a television set 355 for consumption by a cable television/services system customer. As is known to those skilled in the art, HFC networks 685 combine both optical fiber and coaxial cable lines. Typically, optical fiber runs from the cable head end 635 to neighborhoods of 500 to 2,000 customers. Coaxial cable runs from the optical fiber feeders to each customer. According to embodiments of the present invention, the functionality of the HFC network 685 allows for efficient bidirectional data flow between the client-side set-top box 350 and the server-side application server 640 of the present invention.

According to embodiments of the present invention, the CATV system 108 is in the form of a distributed client-server computing system for providing video and data flow across the HFC network 685 between server-side services providers (e.g., cable television/services providers) via a server-side (backend) head end 635 and a client-side customer via a client-side set-top box (STB) functionally connected to a customer receiving device, such as the television set 355. As is understood by those skilled in the art, modern CATV systems 108 may provide a variety of services across the HFC network 685 including traditional digital and analog video programming, telephone services, high speed Internet access, video-on-demand, and information services.

On the client side of the CATV system 108, digital and analog video programming and digital and analog data are provided to the customer television set 355 via the set-top box (STB) 350. Interactive television services that allow a customer to input data to the CATV system 108 likewise are provided by the STB 350. As illustrated in FIG. 6, the STB 350 is a multipurpose computing device having a computer processor, memory and an input/output mechanism. The input/output mechanism of a STB 350 receives input from server-side processes via the HFC network 685 and from customers via input devices such as the remote control device 628 and the keyboard 630. The remote control device 628 and the keyboard 630 may communicate with the STB 350 via a suitable communication transport such as the infrared connection 632. The STB 350 also includes a video processor for processing and providing digital and analog video signaling to the television set 355 via a cable communication transport 634. A multi-channel tuner is provided for processing video and data to and from the STB 350 and the server-side head end system 635, described below. As should be appreciated, functionality of a STB 350 may reside in a stand-alone device, or alternatively, be performed by hardware resident elsewhere, such as within a television 355 or by a suitably equipped terminal device.

The STB 350 also includes an operating system 622 for directing the functions of the STB 350 in conjunction with a variety of client applications 625. For example, if a client application 625 requires a news flash from a third-party news source to be displayed on the television 355, the operating system 622 may cause the graphics functionality and video processor of the STB 350, for example, to output the news flash to the television 355 at the direction of the client application 625 responsible for displaying news items.

Because a variety of different operating systems 622 may be utilized by a variety of different brands and types of set-top boxes, a middleware layer 624 is provided to allow a given software application to be executed by a variety of different operating systems. According to an embodiment of the present invention, the middleware layer 624 may include a set of application programming interfaces (API) that are exposed to client applications 625 and operating systems 622 that allow the client applications to communicate with the operating systems through common data calls understood via the API set. As described below, a corresponding middleware layer is included on the server side of the CATV system 108 for facilitating communication between the server-side application server and the client-side STB 350. According to one embodiment of the present invention, the middleware layer 642 of the server-side application server and the middleware layer 624 of the client-side STB 350 format data passed between the client side and server side according to the Extensible Markup Language (XML). As should be appreciated XML is only one example formatting type and other suitable formatting languages or types may be utilized. As also should be appreciated by those skilled in the art, although some embodiments described in this specification are oriented to middleware installed and executed on a STB 350, alternative embodiments implemented as firmware or as hardware are well within the scope of the present invention.

According to one embodiment, the set-top box 350 passes digital and analog video and data signaling to the television 355 via a one-way communication transport 634. According to other embodiments, two-way communication transports may be utilized, for example, via high definition multimedia (HDMI) ports. The STB 350 may receive video and data from the server side of the CATV system 108 via the HFC network 685 through a video/data downlink and data via a data downlink. The STB 350 may transmit data from the client side of the CATV system 108 to the server side of the CATV system 108 via the HFC network 685 via one data uplink. The video/data downlink is an “in band” downlink that allows for digital and analog video and data signaling from the server side of the CATV system 108 through the HFC network 685 to the set-top box 350 for use by the STB 350 and for distribution to the television set 355. As is understood by those skilled in the art, the “in band” signaling space may operate across a variety of frequency ranges, for example, at a frequency between 54 and 1000 megahertz. The signaling space is generally divided into 6 megahertz channels in which may be transmitted a single analog signal or a greater number (e.g., up to ten) digital signals.

The data downlink and the data uplink, illustrated in FIG. 6, between the HFC network 685 and the set-top box 350 comprise “out of band” data links. As is understand by those skilled in the art, the “out of band” frequency range generally lies between zero and 54 megahertz. According to embodiments of the present invention, data flow between the client-side set-top box 350 and the server-side application server 640 is typically passed through the “out of band” data links. Alternatively, an “in band” data carousel may be positioned in an “in band” channel into which a data feed may be processed from the server-side application server 640 through the HFC network 685 to the client-side STB 350. Operation of data transport between components of the CATV system 108, described with reference to FIG. 6, is well known to those skilled in the art.

Referring still to FIG. 6, the head end 635 of the CATV system 108 is positioned on the server side of the CATV system and includes hardware and software systems responsible for originating and managing content for distributing through the HFC network 685 to client-side STBs 350 for presentation to customers via televisions 355. As described above, a number of services may be provided by the CATV system 108, including digital and analog video programming, interactive television services, telephone services, video-on-demand services, targeted advertising, and provision of information content.

The application server 640 is a general-purpose computing system operative to assemble and manage data sent to and received from the client-side set-top box 350 via the HFC network 685. As described above with reference to the set-top box 350, the application server 640 includes a middleware layer 642 for processing and preparing data from the head end of the CATV system 108 for receipt and use by the client-side set-top box 350. For example, the application server 640 via the middleware layer 642 may obtain data from third-party services 645 via an IP network 625 (e.g., Internet) for transmitting to a customer through the HFC network 685 and the set-top box 350. For example, a weather report from a third-party weather service may be downloaded by the application server via the Internet 625. When the application server 640 receives the downloaded weather report, the middleware layer 642 may be utilized to format the weather report for receipt and use by the set-top box 350. According to one embodiment of the present invention, data obtained and managed by the middleware layer 642 of the application server 640 is formatted according to the Extensible Markup Language and is passed to the set-top box 350 through the HFC network 685 where the XML-formatted data may be utilized by a client application 625 in concert with the middleware layer 624, as described above. As should be appreciated by those skilled in the art, a variety of third-party services data, including news data, weather data, sports data and other information content, may be obtained by the application server 640 via distributed computing environments such as the Internet 625 for provision to customers via the HFC network 685 and the set-top box 350. According to an embodiment of the present invention, digital video recording functionality may be located remotely on the head end (server side) 635 and called upon by a client set-top box 350.

As illustrated in FIG. 6, the service provider data services 660 include a number of services operated by the services provider of the CATV system 108 which may include data on a given customer. For example, a billing system 662 may include information such as a customer's name, street address, business identification number, Social Security number, credit history, and information regarding services and products subscribed to by the customer. An electronic mail system 664 may contain information such as electronic mail addresses, high-speed Internet access subscription information and electronic mail usage data. An authentication system 666 may include information such as secure user names and passwords utilized by customers for access to network services.

The customer information database 668 may include general information about customers such as place of employment, business address, business telephone number and demographic information such as age, gender, educational level, and the like. The customer information database may also include information on products and services subscribed to by a customer from her cable services provider. For example, in accordance with embodiments of the present invention, the customer information database may contain data to allow a determination as to whether a particular product or service is already provisioned at a customer service address or whether a work order is pending for a particular product or service provisioning at the customer service address. The customer information database may also include information that allows for a determination as to whether prerequisites for provisioning a requested product of service are met by a requesting customer. For example, if a customer requests electronic mail services and high speed Internet access is a prerequisite for electronic mail services, the customer information database may be queried to determine whether the required Internet access is provisioned at the requesting customer location or address.

As should be understood by those skilled in the art, the disparate data services systems 662, 664, 666, 668 are illustrated as a collection of data services for purposes of example only. The example data services systems comprising the data services 660 may operate as separate data services systems, which communicate with a web services system (described below) along a number of different communication paths and according to a number of different communication protocols

Referring still to FIG. 6, a web services system 657 is illustrated between the application server 640 and the data services 660. According to embodiments of the present invention, the web services system 657 serves as a collection point for data requested from each of the disparate data services systems comprising the data services 660. When the application server 640 requires customer profile data from one or more of the data services 660 for preparation or update of a customer profile, the application server 640 passes a data query to the web services system 657. The web services system formulates a data query to each of the available data services systems for obtaining any available data for a given customer as identified by a set-top box identification associated with the customer. The web services system 657 serves as an abstraction layer between the various data services systems and the application server 640. That is, the application server 640 is not required to communicate with the disparate data services systems, nor is the application server 640 required to understand the data structures or data types utilized by the disparate data services systems. The web services system 657 is operative to communicate with each of the disparate data services systems for obtaining necessary customer profile data. The customer profile data obtained by the web services system is assembled and is returned to the application server 640 for ultimate processing via the middleware layer 642, as described above.

According to embodiments of the present invention, a mobile computing device 100 may access a CATV system 108 via a wireless network connected to an IP network 625, or through an access point base station 604 connected to an IP network, as illustrated in FIG. 6 A mobile computing device may access a CATV system 108 in order to access and utilize one or more applications, features or services available to the user via the CATV 108. The mobile computing device 100 may gain access to a desired application in a variety of suitable methods. According to one method, the mobile computing device 100 may access the CATV 108 via the IP network 625 to the Web Services System 657 and Data Services platform 660.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention. Although embodiments of the present invention have been described with reference to particular standards and protocols, the present invention is not limited to such standards and protocols.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a location status update associated with a mobile computing device, the method comprising:
receiving a request to send a location status update associated with the mobile computing device to one or more recipients;
receiving a location status update criterion for determining whether a location status update should be sent to the one or more recipients;
receiving positioning information for the mobile computing device;
determining if the location status update criterion has been met according to the positioning information associated with received for the mobile computing device; and
if the location status update criterion has been met, sending the location status update to the one or more recipients.

2. The method of claim 1, wherein the location status update comprises an electronic message sent to a receiving computing device.

3. The method of claim 2, wherein the receiving computing device is a video-capable computing device.

4. The method of claim 2, wherein the receiving computing device is a mobile computing device.

5. The method of claim 2, wherein the receiving computing device is a computer.

6. The method of claim 2, wherein the electronic message includes an electronic mail, an SMS message, an MMS message, a text message, a voice message, or a social networking posting.

7. The method of claim 1, wherein the location status update includes a voice call.

8. The method of claim 1, wherein the criterion associated with the request to send the location status update includes a proximity to a geographic location.

9. The method of claim 1, wherein the criterion associated with the request to send the location status update includes a time duration.

10. The method of claim 8, wherein the proximity to a geographic location is determined by location information obtained by processed positioning signals received by a GPS system.

11. The method of claim 8, wherein the proximity to a geographic location is determined by a wireless communications based location determining system.

12. The method of claim 8, wherein the proximity to a geographic location is determined by an accelerometer-based location determining system.

13. The method of claim 1, wherein the location status update includes a geographic location of the mobile computing device, a departing time of the mobile computing device, a departing location for the mobile computing device, an estimated time remaining until arrival of the mobile computing device at a prescribed location, travel condition information, a distance traveled of the mobile computing device, a distance remaining for the mobile computing device to a prescribed location, a message from a user of the mobile computing device, or a message from a recipient of the location status update.

14. A computer-readable medium which stores a set of instructions which when executed performs a method for providing a location status update associated with a mobile computing device, the method executed by the set of instructions comprising:
receiving a request to send a location status update to one or more recipients;
associating a location status update criterion with the request to send the location status update;
receiving and processing positioning information for the mobile computing device;
determining if the location status update criterion has been met according to positioning information for the mobile computing device; and
in response to determining if the location status update criterion has been met, sending a status update to the one or more recipients.

15. The computer-readable medium of claim 14, wherein the location status update criterion associated with the request to send the location status update includes a proximity to a geographic location.

16. The computer-readable medium of claim 14, wherein the location status update criterion associated with the request to send the location status update includes a time duration.

17. The computer-readable medium of claim 15, wherein the proximity to a geographic location is determined by location information obtained by processed positioning signals received by a GPS system.

18. The computer-readable medium of claim 15, wherein the proximity to a geographic location is determined by a wireless communications based location determining system.

19. The method of claim 15, wherein the proximity to a geographic location is determined by an accelerometer-based location determining system.

20. The computer-readable medium of claim 14, wherein the location status update includes a geographic location of the mobile computing device, a departing time of the mobile computing device, a departing location for the mobile computing device, an estimated time remaining until arrival of the mobile computing device at a prescribed location, travel condition information, a distance traveled of the mobile computing device, a distance remaining for the mobile computing device to a prescribed location, a message from a user of the mobile computing device, or a message from a recipient of the location status update.

21. A system for providing a location status update associated with a mobile computing device, the system comprising:
a memory storage;
a processing unit coupled to the memory storage, wherein the processing unit is operative to:
receive a request to send a location status update to one or more recipients;
associate a location status update criterion with the request to send the location status update;
receive and processing positioning information for the mobile computing device;
determine if the location status update criterion has been met according to the positioning information for the mobile computing device; and
in response to determining if the criterion has been met, to send a location status update to the one or more recipients.

22. The system of claim 21, further comprising a location determining system operative to receive and process positioning information for the mobile computing device for determining whether the location status update criterion has been met.
